(19) United States
(12) Patent Application Publication
(10) Pub. No.: US 2026/0277605 A1
(43) Pub. Date: Sep. 17, 2026

(54) MULTI-VECTOR INSTRUCTION SET ARCHITECTURE FOR ML ACCELERATORS

(71) Applicant: QUALCOMM Incorporated, San Diego, CA (US)

(72) Inventors: Sundar Rajan BALASUBRAMANIAN, Groton, MA (US); Aditya AWASTHI, San Diego, CA (US); Troy LI, Irvine, CA (US); Cheng JIANG, San Diego, CA (US); Chirag HETHUR VEERESHA, San Marcos, CA (US); Jainam SHAH, San Diego, CA (US)

(21) Appl. No.: 19/076,702

(22) Filed: Mar. 11, 2025

(51) Int. Cl. G06F 9/30; G06F 15/82

(52) U.S. Cl. CPC G06F 9/30036; G06F 15/82

(57) ABSTRACT

This disclosure provides systems, methods and apparatuses for acceleration of machine-learning (ML) operations. A hardware accelerator executes multi-vector instructions. The hardware accelerator includes a core controller configured to receive a multi-vector instruction for a first operation on a matrix, the instruction indicating a vector length and a number of vectors. The accelerator includes a write control block configured to write data into a buffer corresponding to the matrix. The accelerator includes a compute block configured to perform the operation indicated by the multi-vector instruction on each of the number of vectors. The accelerator includes an output format block configured to output a result defined for the multi-vector instruction.

### TECHNICAL FIELD

The present disclosure relates to integrated circuits including multi-vector instruction set architectures for machine-learning (ML) accelerators.

### DESCRIPTION OF THE RELATED TECHNOLOGY

Machine-learning models such as neural networks utilize layers that implement algorithmic steps on multiple nodes. For example, neural networks may include transformer or multi-head attention architectures, for example, in large language models (LLMs). Computation of the algorithmic steps can consume significant computing resources, especially on constrained platforms having limited memory, bandwidth, or compute resources. For instance, resource constraints may impact generative artificial intelligence (AI) implementation on edge devices, AI/ML models for smart devices including smart home appliances, and modem algorithms using neural networks. Useful AI and ML models are often implemented on network or cloud resources (e.g., datacenters) where resources are less constrained. Such implementations, however, have their own concerns such as privacy, security, and transmission bandwidth and latency.

### SUMMARY

The systems, methods and devices of this disclosure each have several innovative aspects, no single one of which is solely responsible for the desirable attributes disclosed herein.

In some aspects, the techniques described herein relate to a hardware accelerator for executing multi-vector instructions including: a core controller configured to receive a multi-vector instruction for a first operation on a matrix, the instruction indicating a vector length and a number of vectors; a write control block configured to write data into a buffer corresponding to the matrix; a compute block configured to perform the operation indicated by the multi-vector instruction on each of the number of vectors; and an output format block configured to output a result defined for the multi-vector instruction.

In some aspects, the techniques described herein relate to a method, including: receiving, at a hardware accelerator, a multi-vector instruction for a first operation on a matrix, the instruction indicating a vector length and a number of vectors; performing the first operation indicated by the multi-vector instruction on each of the number of vectors; and outputting a result defined for the multi-vector instruction.

In some aspects, the techniques described herein relate to an apparatus, including: a first processor configured to issue a multi-vector instruction to a hardware accelerator for a first operation on a matrix, the instruction indicating a vector length and a number of vectors; and the hardware accelerator, including: a core controller configured to receive a multi-vector instruction for a first operation on a matrix, the instruction indicating a vector length and a number of vectors; a write control block configured to write data into a buffer corresponding to the matrix; a compute block configured to perform the operation indicated by the multi-vector instruction on each of the number of vectors; and an output format block configured to output a result defined for the multi-vector instruction.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of an architecture of a hardware accelerator for machine-learning (ML).

FIG. 2 is a diagram illustrating an example of a soft-max operation using multi-vector instructions.

FIG. 3 is a diagram of an example post processing unit (PPU) for multi-vector instructions.

FIG. 4 is a flowchart of an example method of accelerating ML operations using multi-vector instructions.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways.

In some implementations, the accelerator architectures described herein may implement wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G or 5G, 6G or further implementations thereof, technology. However, the apparatuses and techniques described herein may be implemented in any device, system or network regardless of compliance any particular standard specification.

Machine-learning (ML) and artificial intelligence (AI) utilize models including multiple nodes that perform operations. For example, common models include neural networks and transformer networks. These models include multiple layers that involve similar operations performed on every row of a matrix. For example, Query-Key correlation within transformer networks requires the softmax function on every row of a matrix. The softmax function converts a vector of real numbers into a probability distribution. As another example, layer normalization within transformer networks may require average and/or variance computation of every row of a matrix.

Vector processors can accelerate ML and AI models by performing atomic operations on multiple elements in a vector. The more complicated ML and AI functions can be performed as a series of atomic operations. The serialization of atomic operations, however, costs processor cycles and may involve repeated movement of data. An alternative approach to serial operation is to fuse the operations of a function in a custom hardware accelerator. Such custom hardware accelerators, however, may be relatively expensive and may have limited use in a general purpose device.

In an aspect, the present disclosure provides an architecture for a hardware accelerator to support a multi-vector instruction set. A multi-vector instruction set performs an operation on each vector of a specified vector length (VEC_LENGTH) looping over a specified number of vectors (NUM_VECTORs). For instance, a multi-vector instruction set can perform the operation on each row of a matrix. The multi-vector instructions can be utilized in a wide variety of ML and AI functions. Each multi-vector instruction may fuse several atomic operations, providing reduced processor cycles and less data movement than serialized operations.

Table 1 show example multi-vector instruction names, functional behavior of each multi-vector instruction, and example operands. In some implementations, the below multi-vector instructions may form a multi-vector instruction set. A processor may issue one or more instructions from the multi-vector instruction set to a hardware accelerator.

TABLE 1

| Instructions | Functional Behavior | Operands |
|---|---|---|
| MVEC_ADDSUB | Multi-vector add/subtract. | Input1: matrix |
| | Add/subtract op on every row of | Input2: vector |
| | input1 with a splatted scalar from input2. | Output1: matrix |
| MVEC_SCALE | Multi-vector scale operator. | Input1: matrix |
| | Scale op on every row of input1 | Input2: vector |
| | with a splatted scalar from input2. | Output1: matrix |
| | 16 x 16 or 32 x 16 multiply | |
| MVEC_SCALESHIFT | Multi-vector scale and shift. | Input1: matrix |
| | Scale op on every row of input1 | Input2: scale vector |
| | with a splatted scalar from | Input3: shift vector |
| | input2, followed by variable | Output1: matrix |
| | shift scalar amount from input3. | |
| | 16 x 16 or 32 x 16 multiply, | |
| | followed by a programmable shift | |
| MVEC_ADDREDUCE | Multi-vector add-reduce. Add | Input1: matrix |
| | reduce op on every row of | Output1: vector |
| | input1 to a scalar element in output1. | |
| MVEC_ADDREDUCE | Multi-vector add reduce, | Input1: matrix |
| _NORM | followed by variable | Output1: vector |
| | normalization. Add reduce op | mantissa |
| | on every row of input1 to a | Output2: vector |
| | scalar mantissa in output1 and | exponent |
| | scalar exponent in output2. | |
| MVEC_SQUAREREDUCE | Multi-vector Square reduce. | Input1: matrix |
| | Sum of squares op on every row | Output1: vector |
| | of input1 to a scalar element in | |
| | output1. | |
| MVEC_SQUAREREDUCE | Multi-vector square reduce, | Input1: matrix |
| _NORM | followed by variable | Output1: vector |
| | normalization. Sum of squares | mantissa |
| | op on every row of input1 to a | Output2: vector |
| | scalar mantissa in output1 and | exponent |
| | scalar exponent in output2 | |
| MVEC_REVERSE | Multi-vector row reverse. | Input1: matrix |
| | Reverse the order of all | Output1: matrix |
| | elements in each row and repeat | |
| | the operation for all rows of the | |
| | multi-vector. | |
| | Useful for reflective padding of | |
| | a tensor. | |

Several aspects of accelerator architectures will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

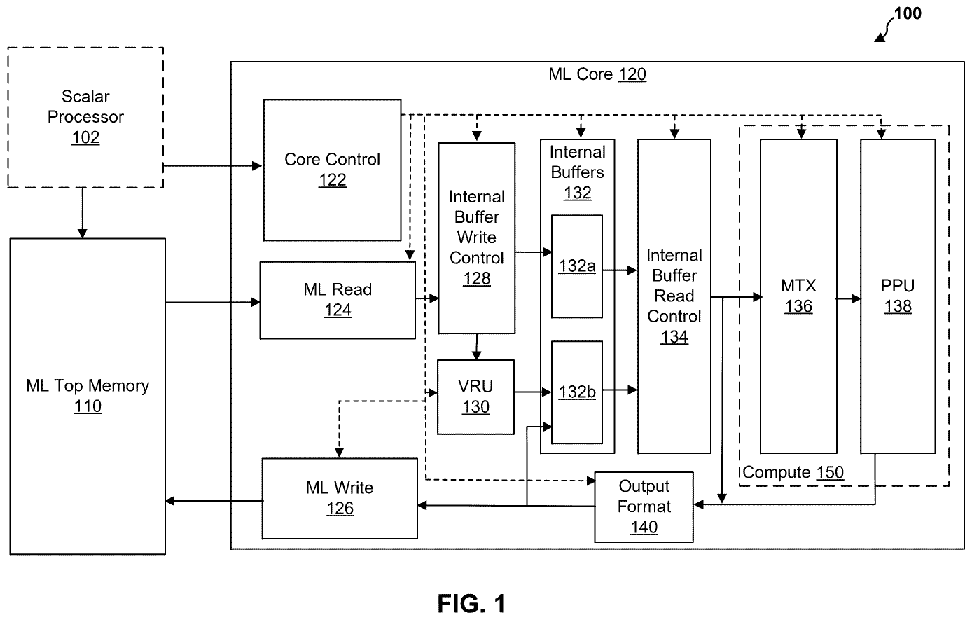

FIG. 1 is a diagram illustrating an example of an architecture of a hardware accelerator 100 for machine-learning (ML). The hardware accelerator 100 may include a ML top memory 110 and a ML core 120. The hardware accelerator 100 may communicate with a scalar processor 102 (e.g., a central processing unit (CPU)). For instance, the scalar processor 102 may provide instructions to the core control 122 and load data to the ML top memory 110. The ML core 120 may include multiple hardware blocks. For example, the ML core 120 may include a ML read block 124, an ML write block 126, an internal buffer write control block 128, a vector reduce unit (VRU) 130, a buffer 132, an internal buffer read control block 134, a matrix (MTX) block 136, and a post processing unit (PPU) 138. In an aspect, each of the blocks may be configured to loop vector operations over multiple rows to perform the operation on a matrix.

The ML top memory 110 is configured to store data for processing by the ML core 120. For example, the ML top memory 110 may load a matrix based on instructions from the scalar processor 102. The ML top memory 110 may be read by ML read block 124. The ML write block 126 may write to the ML top memory 110.

The core control 122 is configured to control each of the other components of the ML core 120. For example, the core control 122 may receive a multi-vector instruction from the scalar processor 102. For instance, the multi-vector instruction may be selected from the multi-vector instruction set in Table 1. In some implementations, the multi-vector instruction includes an operation code that identifies the operation, a source memory address, a destination memory address, a vector length, a number of vectors, and a control register. In some implementations, instructions may be received as a task including multiple instruction words. For instance, as discussed in further detail below, the softmax operation may be a task including a multi-vector min/max reduce followed by subtract operation (MVecMreduceSub), a multi-vector add-reduce-normalize operation (MVecAddReduce), and a multi-vector scale and shift operation (MVecScaleShift).

The write control block 128 is configured to write the input data into the buffer 132 based on the multi-vector instruction. In particular, the write control block 128 may write the input data into the number of vectors of vector length. In some implementations, the write control block 128 may provide input vectors to the VRU 130. The VRU 130 is configured to perform a vector reduction on the input vector as the input vector is being read into the buffer 132. Accordingly, the VRU 130 may allow fusion of vector reduce operations in multi-vector instructions such as MVEC_MREDUCE and MVEC_MREDUCE_SUB.

The internal buffers 132 store the matrix for operations by the MTX block 136. In some implementations, the internal buffers 132 includes a first buffer 132a and a second buffer 132b. In some implementations, the second buffer 132b may be written to by the output format block 140. For example, the results of a first multi-vector instruction can be written to the second buffer 132b without being written to the ML top memory 110 to reduce movement of data. The results of the first multi-vector instruction can then be used as the input matrix for a second multi-vector instruction without reloading data from the ML top memory 110.

The internal buffer read control block 134 is configured to read data out of the internal buffer 132. The internal buffer read control block 134 computes a read/compute order and read address based on the multi-vector instruction. In some implementations, the internal buffer read control block 134 is tightly coupled with the buffers 132. In some implementations, the output of the internal buffer read control block 134 may be output to either the output format block 140 (no further processing) or to the MTX block 136 (for further processing).

The MTX block 136 is configured to perform matrix operations as vector operations on a row of a matrix, looping the vector operations over multiple rows. The MTX block 136 may be referred to as a compute block 150. For example, the vector operations may include atomic operations such as add, subtract, multiply, multiply-accumulate, etc. The atomic operations may be selected based on the multi-vector instruction. The compute block 150 may perform arithmetic operations such as quantizing, normalizing, or dequantizing based on a precision indicated by the multi-vector instruction.

The PPU 138 is configured to perform post-processing operations. In some implementations, the PPU 138 is combined with the MTX block 136 in a single compute block 150. In an aspect, the PPU 138 may support multiple PPU modes. The PPU modes may be associated with different data types and bitwidths for the input and output to the PPU 138. For example, the data types may include signed or unsigned, and the bitwidths may be 8, 16, or 32 bits. In an implementation, each multi-vector instruction may specify a data type and bitwidth for each operand. The multi-vector instruction may indicate a PPU mode. The PPU 138 may perform operations such as scaling, shifting, linear approximation, etc. The PPU 138 may perform the post-processing operations based on the format of the input and output (e.g., data types) and the indicated PPU mode.

The output format block 140 is configured to format the output according to the multi-vector instruction. For example, the output format block 140 may obtain data from the internal buffer read control block 134 or the PPU 138 and format the data as at least one of a matrix or vector. In some implementations, the output format block 140 may write the output back to the buffer 132 for further multi-vector instructions.

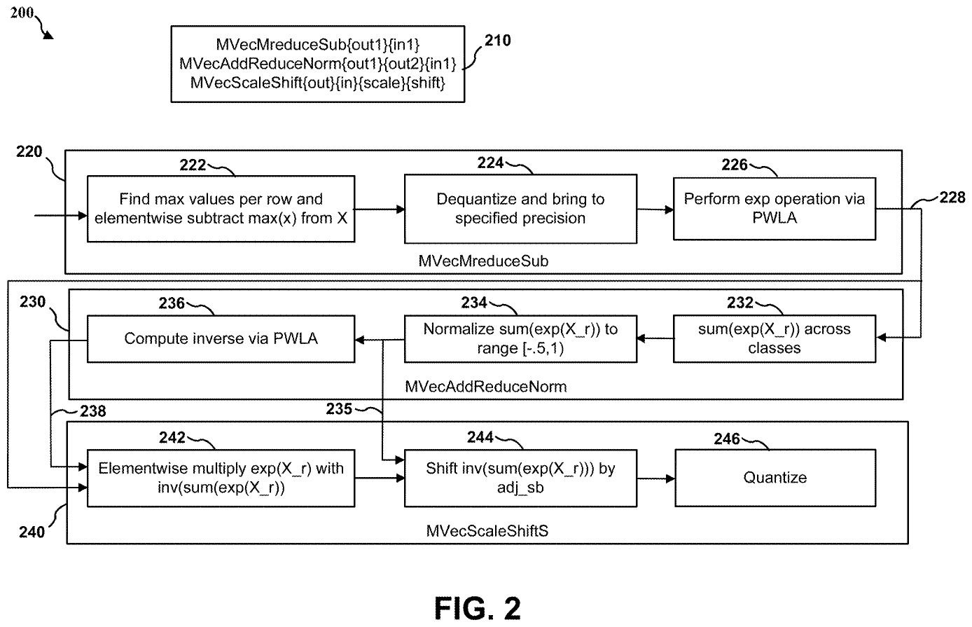

FIG. 2 is a diagram 200 illustrating an example of a soft-max operation using multi-vector instructions. For example, the scalar processor 102 may schedule a task 210 for the soft-max operation. For instance, the softmax operation may have a batch size of n, and a number of classes k, and a bitwidth (bw) of 8 or 16. The task 210 includes three multi-vector instructions: VecMreduceSub 220, MVecAddReduceNorm 230, and MVecScaleShift 240. The ML core 120 can execute each multi-vector instruction as a series of fused sub-operations.

The VecMreduceSub 220 instruction may perform multi-vector min/max reduce followed by subtracting of vector from the min/max element. The VecMreduceSub 220 instruction may take a matrix as input and output another matrix. At sub-operation 222, the ML core 120 may find the max value per row and elementwise subtract the max value from the vector. For example, the VRU 130 may find the max value per row as the input matrix is read to the buffer 132. The internal buffer read control block 134 may then perform the subtraction atomic operation on each row, looping over the number of rows. In sub-operation 224, the MTX block 136 may dequantize the matrix and bring the values to a designated precision. For example, the precision may be the bitwidth of the output operand. In sub-operation 226, the PPU 138 may perform the exponential operation via piece-wise linear approximation (PWLA). Accordingly, the output of the VecMreduceSub 220 instruction may be an output matrix 228. The output matrix 228 may be stored as an input to both the MVecAddReduceNorm 230 instruction and the MVecScaleShift 240 instruction.

The MVecAddReduceNorm 230 instruction may perform multi-vector add reduce, followed by variable normalization. That is, the ML core 120 may add the elements of each row to reduce the row to a scalar mantissa in an output vector (output1) and calculate a scalar exponent vector (output2). Each row may represent a class. In sub-operation 232, the internal buffer read control block 134 may sum the rows of the output matrix 228 resulting in a vector (output1). In sub-operation 234, the MTX block 136 may normalize the sums to a range of [−0.5,1). The normalized vector 235 may be stored for input into sub-operation 244. In sub-operation 236, the PPU 138 may compute the inverse of the normalized vector via PWLA. The inverse vector 238 may be stored for input to the MVecScaleShift 240 instruction.

The MVecScaleShift 240 instruction performs a scale operation on every row of input1 with a splatted scalar from input2, followed by a variable shift scalar amount from input3. For instance, input1 may be the matrix 228, input2 may be the inverse vector 238, and input3 may be the normalized vector 235. In sub-operation 242, the internal buffer read control block 134 may elementwise multiply the exponential values (exp(X_r)) of the matrix 228 with the values of the inverse vector 238. In sub-operation 244, the MTX block 136 may shift each row of the resulting matrix by the value of the normalized vector 235. In sub-operation 246, the PPU 138 may quantize the shifted values of the matrix. The MVecScaleShift 240 instruction may output a matrix representing a probability distribution of each of the classes.

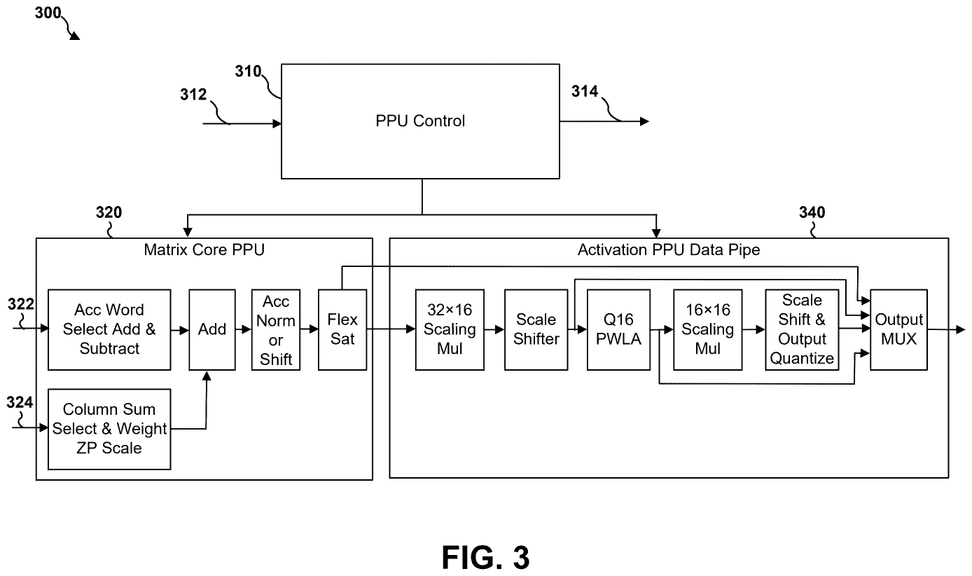

FIG. 3 is a diagram 300 of an example PPU 138 for multi-vector instructions. A PPU control 310 receives an instruction 312 from the MTX block 136. The PPU control 310 outputs an instruction 314 to the output format block 140. The PPU 138 may include a matrix core PPU 320 and an activation PPU data pipe 340.

The matrix core PPU 320 may receive matrix core results 322 and column sum results from the MTX block 136. The matrix core PPU 320 may perform operations on a matrix. For example, the matrix core PPU 320 may perform add, subtract, normalize, or shift operations.

The activation PPU data pipe 340 may perform various scaling operations. The activation PPU data pipe 340 may include an output multiplexor configured to select a stage of the matrix core PPU 320 or the activation PPU data pipe 340 for output to the output format block 140.

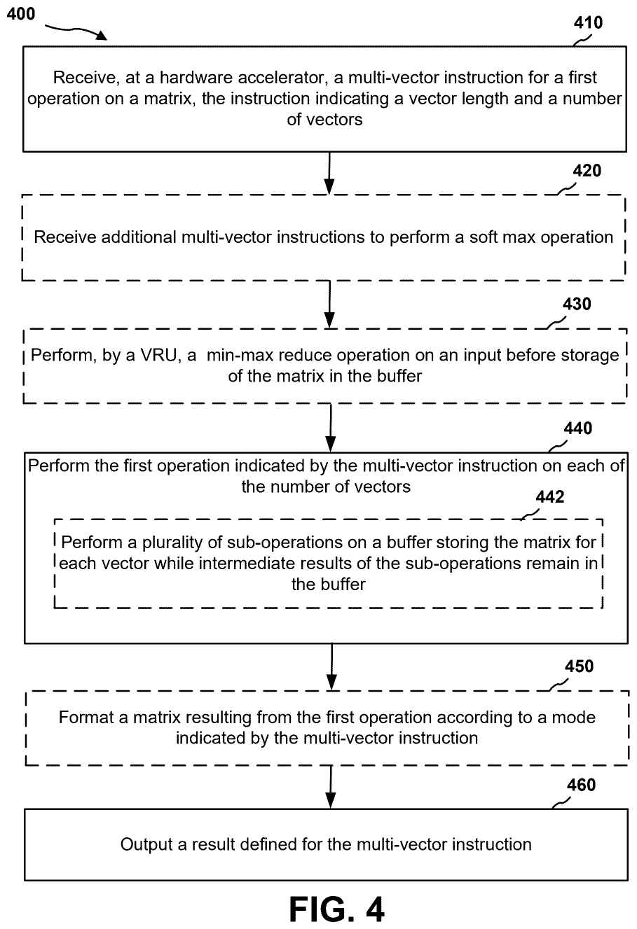

FIG. 4 is a flowchart of an example method 400 of accelerating a machine-learning operation. The method 400 may be performed by the accelerator 100 or a component thereof such as the ML core 120. The method 400 may be performed in communication with a scalar processor 102. Optional blocks are shown with dashed lines.

At block 410, the method 400 includes receiving, at a hardware accelerator, a multi-vector instruction for a first operation on a matrix, the instruction indicating a vector length and a number of vectors. In some implementations, for example, the hardware accelerator 100 and/or the core control 122 receives a multi-vector instruction for a first operation on a matrix. The instruction indicates a vector length and a number of vectors. Accordingly, the hardware accelerator 100 and/or the core control 122 may provide means for receiving, at a hardware accelerator, a multi-vector instruction for a first operation on a matrix.

At block 420, the method 400 may optionally include receiving additional multi-vector instructions to perform a soft max operation. In some implementations, for example, the hardware accelerator 100 and/or the core control 122 may receive additional multi-vector instructions (e.g., task 210) to perform a soft max operation. Accordingly, the hardware accelerator 100 and/or the core control 122 may provide means for receiving additional multi-vector instructions to perform a soft max operation.

At block 430, the method 400 may optionally include performing, by a VRU, a min-max reduce operation on an input before storage of the matrix in the buffer. In some implementations, for example, the hardware accelerator 100 and/or the VRU 130 may perform the min-max reduce operation on an input before storage of the matrix in the buffer 132. Accordingly, the hardware accelerator 100 and/or the VRU 130 may provide means for perform a min-max reduce operation on an input before storage of the matrix in the buffer.

At block 440, the method 400 may optionally include performing the first operation indicated by the multi-vector instruction on each of the number of vectors. In some implementations, for example, the hardware accelerator 100 and/or the internal buffer read control block 134 may perform the first operation indicated by the multi-vector instruction on each of the number of vectors. In some implementations, at sub-block 442, the block 440 may include performing a plurality of sub-operations on a buffer storing the matrix for each vector while intermediate results of the sub-operations remain in the buffer. For example, the intermediate values of the first operation on each of the number of vectors may be stored as 16-bit values in the buffer 132. Accordingly, the hardware accelerator 100 and/or the internal buffer read control block 134 may provide means for performing the first operation indicated by the multi-vector instruction on each of the number of vectors.

At block 450, the method 500 may optionally include formatting a matrix resulting from the first operation according to a mode indicated by the multi-vector instruction. In some implementations, for example, the hardware accelerator 100 and/or the PPU 138 may format a matrix resulting from the first operation according to a mode indicated by the multi-vector instruction. Accordingly, the f hardware accelerator 100 and/or the PPU 138 may provide means for formatting a matrix resulting from the first operation according to a mode indicated by the multi-vector instruction.

At block 460, the method 400 includes outputting a result defined for the multi-vector instruction. In some implementations, for example, the hardware accelerator 100 and/or the output format block 140 may output a result defined for the multi-vector instruction. Accordingly, the hardware accelerator 100 and/or the output format block 140 may provide means for outputting a result defined for the multi-vector instruction.

The following numbered clauses provide an overview of aspects of the present disclosure:
Clause 1. A hardware accelerator for executing multi-vector instructions comprising: a core controller configured to receive a multi-vector instruction for a first operation on a matrix, the instruction indicating a vector length and a number of vectors; a write control block configured to read data into a buffer corresponding to the matrix; a compute block configured to perform the operation indicated by the multi-vector instruction on each of the number of vectors; and an output format block configured to output a result defined for the multi-vector instruction.
Clause 2. The hardware accelerator of clause 1, wherein an input of the multi-vector instruction is a matrix and the result is at least one of a vector or a matrix.
Clause 3. The hardware accelerator of clause 1 or 2, wherein the compute block is configured to perform the first operation indicated by the multi-vector instruction on each of the number of vectors by performing a plurality of sub-operations on a buffer storing the matrix for each vector while intermediate results of the sub-operations remain in the buffer.
Clause 4. The hardware accelerator of clause 3, wherein intermediate values of the first operation on each of the number of vectors are stored as 16-bit values.
Clause 5. The hardware accelerator of clause 3, further comprising a vector reduced unit (VRU) configured to perform a min-max reduce operation on an input before storage of the matrix in the buffer.
Clause 6. The hardware accelerator of any of clauses 1-5, further comprising a post processing unit configured to format a matrix resulting from the first operation according to a mode indicated by the multi-vector instruction.
Clause 7. The hardware accelerator of any of clauses 1-6, wherein the core controller is further configured to receive additional multi-vector instructions to perform a soft max operation, wherein the first operation is a multi-vector min/max reduce followed by subtract operation, a second operation is a multi-vector add-reduce-normalize operation, and a third operation is a multi-vector scale and shift operation.
Clause 8. The hardware accelerator of any of clauses 1-7, wherein the multi-vector instruction comprises an operation code that identifies the operation, a source memory address, a destination memory address, the vector length and the number of vectors, and a control register.
Clause 9. The hardware accelerator of any of clauses 1-8, wherein the multi-vector instruction is selected from a multi-vector instruction set including: a multi-vector min/max reduce instruction; a multi-vector min/max reduce followed by subtract instruction; a multi-vector add/subtract instruction; a multi-vector scale instruction; a multi-vector scale and shift instruction; a multi-vector add-reduce instruction; a multi-vector add-reduce-normalize instruction; a muti-vector square reduce instruction; a multi-vector square reduce normalize instruction; and a multi-vector row reverse instruction.
Clause 10. A method, comprising: receiving, at a hardware accelerator, a multi-vector instruction for a first operation on a matrix, the instruction indicating a vector length and a number of vectors; performing the first operation indicated by the multi-vector instruction on each of the number of vectors; and outputting a result defined for the multi-vector instruction.
Clause 11. The method of clause 10, wherein an input of the multi-vector instruction is a matrix and the result is at least one of a vector or a matrix.
Clause 12. The method of clause 10 or 11, wherein performing the first operation indicated by the multi-vector instruction on each of the number of vectors comprises performing a plurality of sub-operations on a buffer storing the matrix for each vector while intermediate results of the sub-operations remain in the buffer.
Clause 13. The method of clause 12, wherein intermediate values of the first operation on each of the number of vectors are stored as 16-bit values.
Clause 14. The method of clause 12, further comprising performing, by vector reduced unit (VRU), a min-max reduce operation on an input before storage of the matrix in the buffer.
Clause 15. The method of any of clauses 10-14, further comprising formatting a matrix resulting from the first operation according to a mode indicated by the multi-vector instruction.
Clause 16. The method of any of clauses 10-15, further comprising receiving additional multi-vector instructions to perform a soft max operation, wherein the first operation is a multi-vector min/max reduce followed by subtract operation, a second operation is a multi-vector add-reduce-normalize operation, and a third operation is a multi-vector scale and shift operation.
Clause 17. The method of any of clauses 10-16, wherein the multi-vector instruction comprises an operation code that identifies the operation, a source memory address, a destination memory address, the vector length and the number of vectors, and a control register.
Clause 18. The method of any of clauses 10-17, wherein the multi-vector instruction is selected from a multi-vector instruction set including: a multi-vector min/max reduce instruction; a multi-vector min/max reduce followed by subtract instruction; a multi-vector add/subtract instruction; a multi-vector scale instruction; a multi-vector scale and shift instruction; a multi-vector add-reduce instruction; a multi-vector add-reduce-normalize instruction; a muti-vector square reduce instruction; a multi-vector square reduce normalize instruction; and a multi-vector row reverse instruction.
Clause 19. An apparatus, comprising: a first processor configured to issue a multi-vector instruction to a hardware accelerator for a first operation on a matrix, the instruction indicating a vector length and a number of vectors; and the hardware accelerator, comprising: a core controller configured to receive a multi-vector instruction for a first operation on a matrix, the instruction indicating a vector length and a number of vectors; an a write control block configured to read data into a buffer corresponding to the matrix; a compute block configured to perform the operation indicated by the multi-vector instruction on each of the number of vectors; and an output format block configured to output a result defined for the multi-vector instruction.
Clause 20. The apparatus of clause 19, wherein the hardware accelerator is configured as in any of clauses 2-9.

As used herein, a phrase referring to “at least one of” a list of items refers to any combination of those items, including single members. As an example, “at least one of: a, b, or c” is intended to cover: a, b, c, a-b, a-c, b-c, and a-b-c. Similarly, as used herein, a phrase referring to “one or more of” a list of items refers to any combination of those items, including single members. As an example, “one or more of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A hardware accelerator for executing multi-vector instructions comprising:
a core controller configured to receive a multi-vector instruction for a first operation on a matrix, the instruction indicating a vector length and a number of vectors;
a write control block configured to write data into a buffer corresponding to the matrix;
a compute block configured to perform the operation indicated by the multi-vector instruction on each of the number of vectors; and
an output format block configured to output a result defined for the multi-vector instruction.

2. The hardware accelerator of claim 1, wherein an input of the multi-vector instruction is a matrix and the result is at least one of a vector or a matrix.

3. The hardware accelerator of claim 1, wherein the compute block is configured to perform the first operation indicated by the multi-vector instruction on each of the number of vectors by performing a plurality of sub-operations on a buffer storing the matrix for each vector while intermediate results of the sub-operations remain in the buffer.

4. The hardware accelerator of claim 3, wherein intermediate values of the first operation on each of the number of vectors are stored as 16-bit values.

5. The hardware accelerator of claim 3, further comprising a vector reduced unit (VRU) configured to perform a min-max reduce operation on an input before storage of the matrix in the buffer.

6. The hardware accelerator of claim 1, further comprising a post processing unit configured to format a matrix resulting from the first operation according to a mode indicated by the multi-vector instruction.

7. The hardware accelerator of claim 1, wherein the core controller is further configured to receive additional multi-vector instructions to perform a soft max operation, wherein the first operation is a multi-vector min/max reduce followed by subtract operation, a second operation is a multi-vector add-reduce-normalize operation, and a third operation is a multi-vector scale and shift operation.

8. The hardware accelerator of claim 1, wherein the multi-vector instruction comprises an operation code that identifies the operation, a source memory address, a destination memory address, the vector length and the number of vectors, and a control register.

9. The hardware accelerator of claim 1, wherein the multi-vector instruction is selected from a multi-vector instruction set including:
a multi-vector min/max reduce instruction;
a multi-vector min/max reduce followed by subtract instruction;
a multi-vector add/subtract instruction;
a multi-vector scale instruction;
a multi-vector scale and shift instruction;
a multi-vector add-reduce instruction;
a multi-vector add-reduce-normalize instruction;
a muti-vector square reduce instruction;
a multi-vector square reduce normalize instruction; and
a multi-vector row reverse instruction.

10. A method, comprising:
receiving, at a hardware accelerator, a multi-vector instruction for a first operation on a matrix, the instruction indicating a vector length and a number of vectors;
performing the first operation indicated by the multi-vector instruction on each of the number of vectors; and
outputting a result defined for the multi-vector instruction.

11. The method of claim 10, wherein an input of the multi-vector instruction is a matrix and the result is at least one of a vector or a matrix.

12. The method of claim 10, wherein performing the first operation indicated by the multi-vector instruction on each of the number of vectors comprises performing a plurality of sub-operations on a buffer storing the matrix for each vector while intermediate results of the sub-operations remain in the buffer.

13. The method of claim 12, wherein intermediate values of the first operation on each of the number of vectors are stored as 16-bit values.

14. The method of claim 12, further comprising performing, by vector reduced unit (VRU), a min-max reduce operation on an input before storage of the matrix in the buffer.

15. The method of claim 10, further comprising formatting a matrix resulting from the first operation according to a mode indicated by the multi-vector instruction.

16. The method of claim 10, further comprising receiving additional multi-vector instructions to perform a soft max operation, wherein the first operation is a multi-vector min/max reduce followed by subtract operation, a second operation is a multi-vector add-reduce-normalize operation, and a third operation is a multi-vector scale and shift operation.

17. The method of claim 10, wherein the multi-vector instruction comprises an operation code that identifies the operation, a source memory address, a destination memory address, the vector length and the number of vectors, and a control register.

18. The method of claim 10, wherein the multi-vector instruction is selected from a multi-vector instruction set including:
a multi-vector min/max reduce instruction;
a multi-vector min/max reduce followed by subtract instruction;
a multi-vector add/subtract instruction;
a multi-vector scale instruction;
a multi-vector scale and shift instruction;
a multi-vector add-reduce instruction;
a multi-vector add-reduce-normalize instruction;
a muti-vector square reduce instruction;
a multi-vector square reduce normalize instruction; and
a multi-vector row reverse instruction.

19. An apparatus, comprising:
a first processor configured to issue a multi-vector instruction to a hardware accelerator for a first operation on a matrix, the instruction indicating a vector length and a number of vectors; and
the hardware accelerator, comprising:
a core controller configured to receive a multi-vector instruction for a first operation on a matrix, the instruction indicating a vector length and a number of vectors;
a write control block configured to write data into a buffer corresponding to the matrix;
a compute block configured to perform the operation indicated by the multi-vector instruction on each of the number of vectors; and
an output format block configured to output a result defined for the multi-vector instruction.

20. The apparatus of claim 19, wherein the core controller is further configured to receive additional multi-vector instructions to perform a soft max operation, wherein the first operation is a multi-vector min/max reduce followed by subtract operation, a second operation is a multi-vector add-reduce-normalize operation, and a third operation is a multi-vector scale and shift operation.
